(19) United States
(12) Patent Application Publication
(10) Pub. No.: US 2026/0315857 A1
(43) Pub. Date: Oct. 15, 2026

(54) EXERCISE DEVICE

(71) Applicant: NIKE, Inc., Beaverton, OR (US)

(72) Inventors: Andrew P. CONANT, Lake Oswego, OR (US); Zachary T. HALL, Lake Oswego, OR (US); Gabrielle A. RUDD, Lake Oswego, OR (US)

(73) Assignee: NIKE, Inc., Beaverton, OR (US)

(21) Appl. No.: 19/645,947

(22) Filed: Apr. 13, 2026

Related U.S. Application Data
(60) Provisional application No. 63/788,931, filed on Apr. 15, 2025.

(51) Int. Cl. A63B 21/072

(52) U.S. Cl. CPC A63B 21/072

(57) ABSTRACT

An exercise device, the exercise device with a shaft assembly having a first end and a second end opposite the first end, wherein the shaft assembly includes a shaft, a base with an internal thread at an end of the shaft, and an endcap threadingly connected to the base. The shaft assembly includes a tube assembly with a first end and a second end opposite the first end, wherein the second end of the tube assembly receives an end of a barbell. The shaft assembly includes a joint assembly connecting the second end of the shaft assembly and the first end of the tube assembly.

### CROSS-REFERENCE TO RELATED APPLICATION

This application claims priority under 35 U.S.C. §119(e) to Provisional U.S. Patent Application Number 63/788,931, filed Apr. 15, 2025, the disclosure of which is hereby incorporated by reference in its entirety.

### FIELD

The present disclosure relates generally to exercise devices.

### BACKGROUND

This section provides background information related to the present disclosure which is not necessarily prior art.

Certain exercise devices may serve athletes who want to do explosive rotational movements. These exercise devices may allow users to rotate weights around a pivot point. Such exercise devices may be used in combination with barbells. For example, one version of such an exercise device is a landmine. A barbell is loaded with one or more weights on one end, and opposite end of the barbell is inserted into a first end of the landmine. In one version, the second end of the landmine includes a rod which is inserted into the openings of a stack of weights on the floor. In another version, the second end of the landmine is mounted to an exercise rack. The athlete moves the free end of the barbell, and performs explosive moments such as push presses, standing Russian twists, Romanian deadlifts, single leg deadlifts, single arm rows, etc. The length of the barbell distances the user from the pivot point of the landmine.

The version of the landmine in which the second end is inserted into the stack of weights is more mobile than the rack-mounted version, and in turn gives the user space to perform these explosive movements without the worry of hitting the landmine or the stack of weights. The rack mounted version may be more secure than the landmine with the free end inserted into the stack of weights, however the range of motion on some exercises may be limited due to the rack.

### SUMMARY OF THE INVENTION

An exercise device, the exercise device comprising: a shaft assembly comprising a first end and a second end opposite the first end, wherein the shaft assembly comprises a shaft, a base with an internal thread at an end of the shaft, and an endcap threadingly connected to the base; a tube assembly comprising a first end and a second end opposite the first end, wherein the second end of the tube assembly is configured to receive an end of a barbell; and a joint assembly connecting the second end of the shaft assembly and the first end of the tube assembly.

An exercise assembly comprising: an exercise device comprising: a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread, and the endcap is configured to be connected to the internal thread of the base; a tube assembly comprising a first end and a second end opposite the first end, wherein the second end of the tube assembly is configured to receive an end of a barbell; and a joint assembly including yokes connecting the second end of the shaft assembly and the first end of the tube assembly, and a cross spider connecting the yokes to one another; and a barbell, wherein an end of the barbell is received in the second end of the tube assembly.

An exercise assembly comprising: an exercise device comprising: a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread spaced apart from one another, each of the first screw thread and the second screw thread threadingly connectable with the internal thread of the base a tube assembly comprising a first end and a second end opposite the first end, wherein the second end of the tube assembly is configured to receive an end of a barbell; and a joint assembly including a first yoke connecting the second end of the shaft assembly and a second yoke connected to the first end of the tube assembly, and a cross spider connecting the yokes to one another; and a barbell, wherein an end of the barbell is received in the second end of the tube assembly.

### BRIEF DESCRIPTION OF THE DRAWINGS

The drawings described herein are of selected embodiments for illustrative purposes only. Accordingly, the drawings do not include all possible implementations, and are not intended to limit the scope of the present disclosure.

FIG. 1 illustrates an isometric view of an exemplary exercise device, according to some embodiments.

FIG. 2 illustrates a cross-sectional view of the exercise device of FIG. 1, according to some embodiments.

FIG. 3 illustrates a detail view of a shaft assembly and a joint assembly of the exercise device of FIG. 1, according to some embodiments.

FIG. 4 illustrates a detail view the shaft assembly and a portion of the joint assembly of the exercise device of FIG. 1, according to some embodiments.

FIG. 5 illustrates another detail view of the shaft assembly and a portion of the joint assembly of the exercise device of FIG. 4, according to some embodiments.

FIG. 6 illustrates a detail view of a tube assembly and the joint assembly of the exercise device of FIG. 1, according to some embodiments.

FIG. 7 illustrates a detail view the tube assembly and a portion of the joint assembly of the exercise device of FIG. 1, according to some embodiments.

FIG. 8 illustrates another detail view of the tube assembly and part of the joint assembly of the exercise device of FIG. 7, according to some embodiments.

FIG. 9 illustrates a detail view of a portion of the tube assembly, a portion of the shaft assembly, and the joint assembly of the exercise device of FIG. 1, according to some embodiments.

FIG. 10 illustrates an isometric view of an endcap of the exercise device of FIG. 1, according to some embodiments.

FIG. 11 illustrates an isometric view of a sleeve of the exercise device of FIG. 1, according to some embodiments.

FIG. 12 illustrates an exploded view of the exercise device of FIG. 1, according to some embodiments.

FIG. 13 illustrates a detail view of the exercise device of FIG. 1 coupled with an exercise rack and an end of a barbell.

FIG. 14 illustrates a detail view of the exercise device of FIG. 1 coupled with a plurality of bumper plates and an end of a barbell.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope of the disclosure to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below may be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

In the discussion that follows, terms “about,” “approximately,” “substantially,” and the like, when used in describing a numerical value, denote a variation of +/- 10% of that value, unless specified otherwise.

Examples of the present disclosure relate to, among other things, articles of footwear having a sole structure. In one example, the articles of footwear may improve performance of a user. Each of the examples disclosed herein may include one or more of the features described in connection with any of the other disclosed examples. Examples of the present disclosure may incorporate cushioning elements into a sole structure while maintaining an overall height of an article of footwear relatively low/short.

### Exercise Device

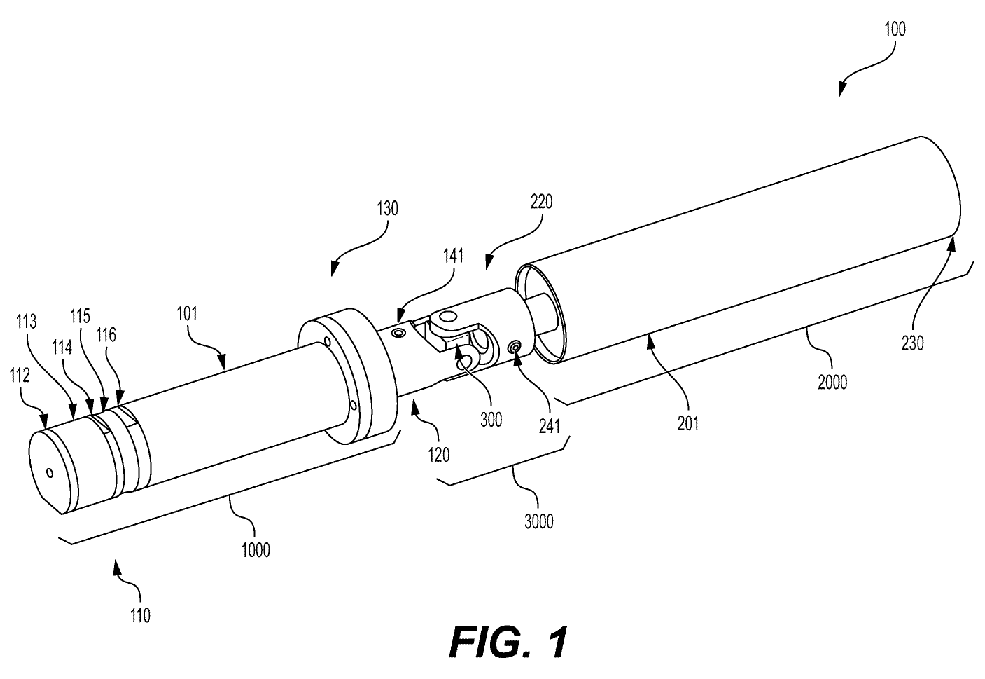

FIG. 1 illustrates an exercise device 100. As shown in the figures, including FIG. 1, the exercise device 100 may be in the form of a landmine. The exercise device 100 may include a shaft assembly 1000, a tube assembly 2000, and a joint assembly 3000 connecting the shaft assembly 1000 and the tube assembly 2000. The shaft assembly 1000 may include, among other components, a shaft 101, an endcap 110 at a first end of the shaft 101, and a connector assembly 130 at a second end of the shaft 101. The endcap 110 may include a first washer, a first gripper 113, and a second washer 114. The shaft 101 may include a third washer 116 and a base 115. The endcap 110 will be described in further detail below.

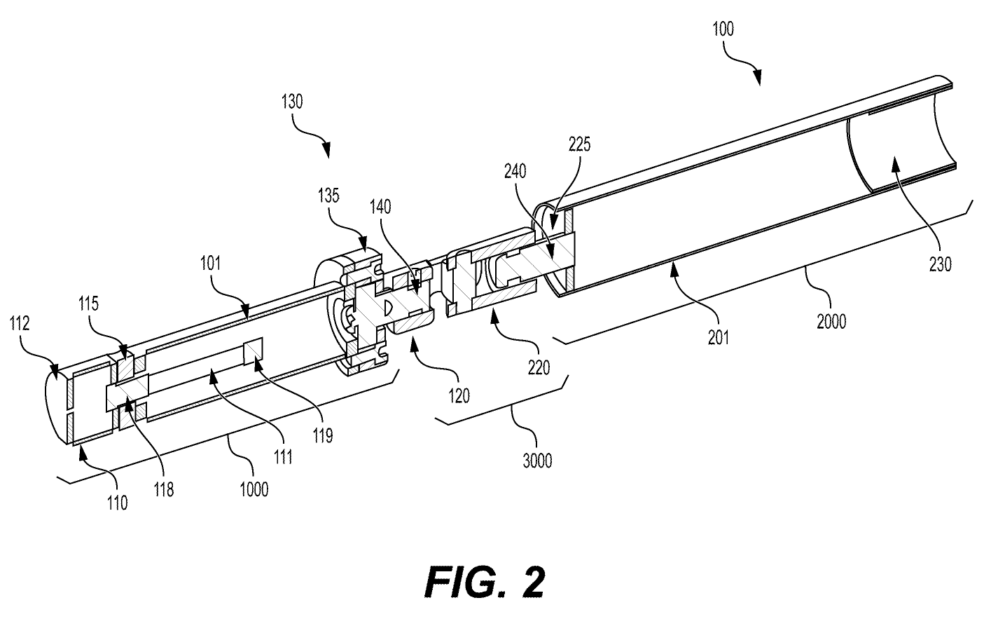

The tube assembly 2000 may include a tube 201 and a sleeve 230 (shown in FIG. 2) at a first end of the tube 201. The joint assembly 3000 may include a yoke 120 at a first end, and a yoke 220 at a second end. The yoke 120 and the yoke 220 may be configured to be coupled to one another using a cross spider 300. The joint assembly 3000 may be in the form of a universal joint (U-joint), and thus the yoke 120 and the yoke 220 may be configured to allow shaft 101 and tube 201 to be to pivot relative to one another.

The yoke 120 and the yoke 220 may be made of steel. In another example, the yoke 120 and the yoke 220 may be made of a hard plastic.

The yoke 120 may be connected to the shaft 101 via the connector assembly 130. The connector assembly 130 may be a cylindrical shape. The radius of the connector assembly 130 may be greater than its height. The connector assembly 130 will be explained further below.

The shaft assembly 1000 may be connected to the joint assembly 3000 by the connector 140 (shown in FIG. 2) and a locking screw 141. The tube assembly 2000 may be connected to the joint assembly 3000 by the connector 240 (shown in FIG. 2) and a locking screw 241.

FIG. 2 illustrates a cross-sectional view of the exercise device 100. The endcap 110 may include a partially threaded rod 111. The partially threaded rod 111 may be configured to allow the endcap 110 to be inserted into the shaft 101, such that different sets of threads of partially threaded rod 111 threadingly engage with threads of the shaft assembly 1000, as further described. The partially threaded rod 111 may include a first screw thread 119 and a second screw thread 118 located at opposite ends of the partially threaded rod. The first screw thread 119 may be an external thread, and it may be located at a first end of the endcap 110, proximal to the joint assembly 3000 when the exercise device 100 is assembled. The second screw thread 118 may be an external thread and it may be located at a second end of the endcap 110, proximal to a first washer 112. The first washer 112 may be a first surface of the endcap.

FIG. 2 also shows that the tube 201 may be hollow, and the sleeve 230 may be open at both of its ends. As such, the tube assembly 2000 may be configured to receive or accept an end of a barbell inserted therein. The tube assembly 2000 may include the connector 240 to connect the tube assembly 2000 to the joint assembly 3000. The connector 240 may be threaded for connection to the tube 210, or it may be adhered to a first surface 225 of the tube 201. The connector 240 may be configured to be connected to the yoke 220.

The shaft 101 may be adhered to the connector assembly 130. The connector assembly 130 may include the connector 140. The connector 140 may be threaded or it may be adhered to a screw mount 135. The connector 140 may be configured to be connected to the yoke 120.

As FIG. 2 shows, the base 115 may be threaded. The thread of the base 115 may be an internal thread, and may be configured to threadingly connect with the threads on the shaft 101. For example, the internal thread of the base 115 may be configured to be coupled with the first screw thread 119 and the second screw thread 118. The internal thread of the base 115 and the external thread of the partially threaded rod 111 may cooperate with each other to removably attach the endcap 110 to the shaft 101.

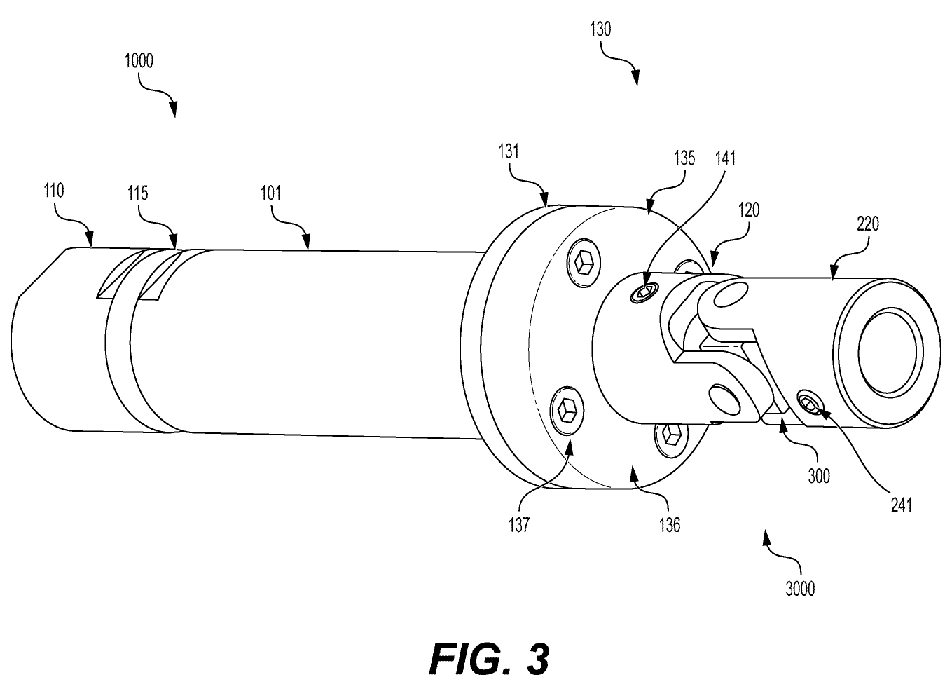

FIG. 3 shows a detail view of the shaft assembly 1000 and the joint assembly 3000. The shaft assembly 1000 may be connected to the yoke 120 which is coupled to the yoke 220. The shaft assembly 1000 may include the connector assembly 130. The connector assembly 130 may include a base 131 and the screw mount 135. The screw mount 135 may have a first surface 136. The first surface 136 may have a plurality of screw holes 137 displaced at equal distances circumferentially. The screws may be hex-screws or screws requiring an Allen wrench. The connector assembly 130, including the base 131 and the screw mount 135, may cooperate with one another to secure the connector 140 to the shaft 101. The base 131 may be made of a similar material to the shaft 101. The screw mount 135 may be made of a more rigid material than the base 131.

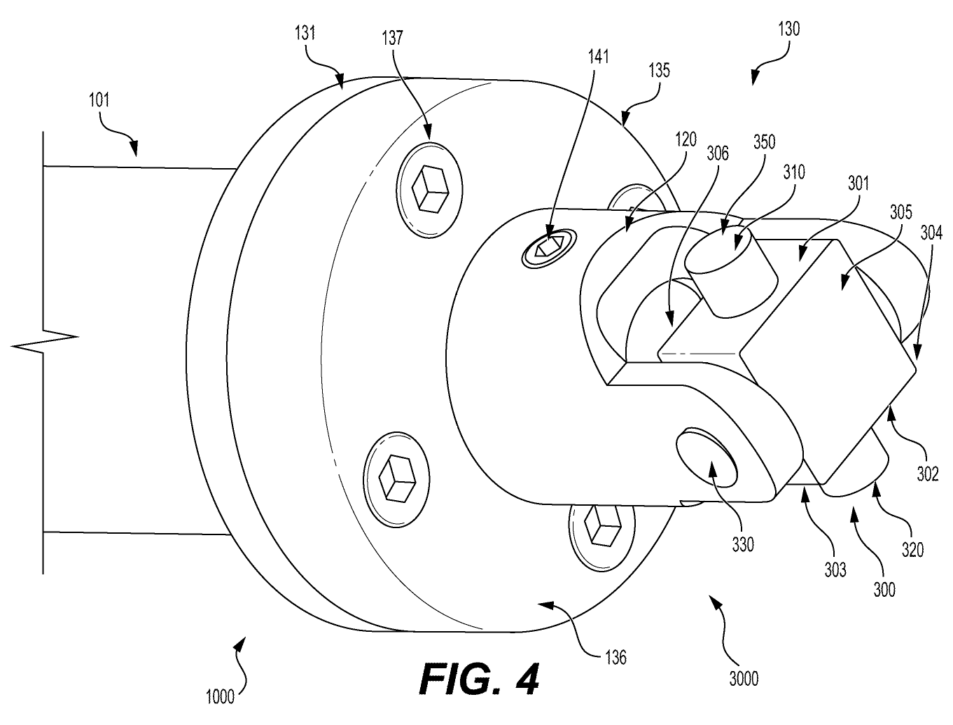

FIG. 4 shows another view of the shaft assembly 1000 and part of the joint assembly 3000. The yoke 120 may be coupled to the yoke 220 by the cross spider 300. As FIG. 4 shows, the cross spider 300 may be a rectangular prism. The cross spider 300 may have a plurality of protrusions 350 extending away from faces of the rectangular prism. Opposite faces of the rectangular prism may define a pair of the plurality of protrusions 350.

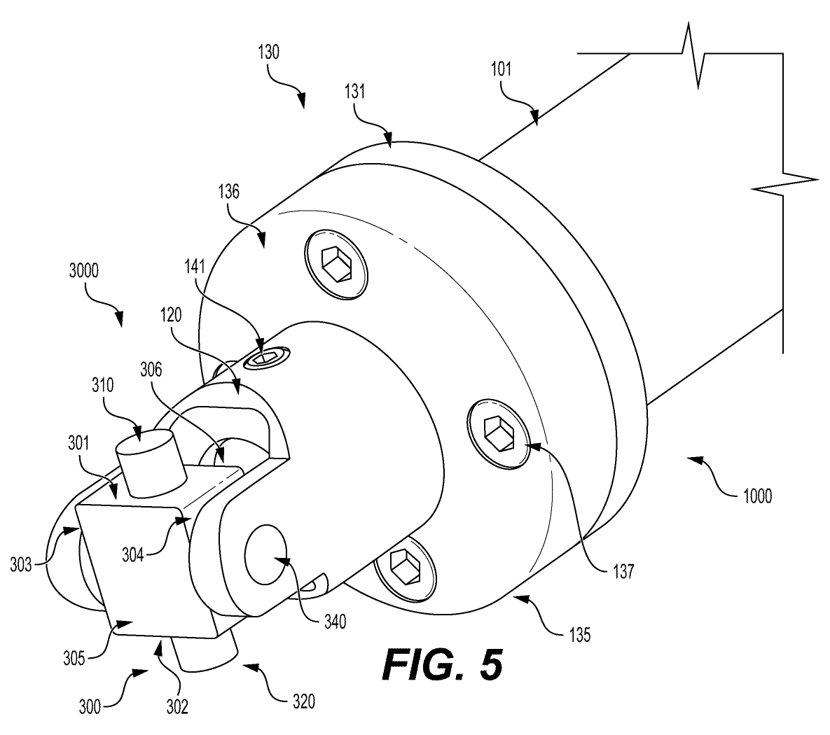

For example, FIG. 4 illustrates four of the six faces of the cross spider 300. The face 301 and the face 302 may be opposite each other, the face 303 and the face 304 may be opposite each other, and the face 305 and the face 306 may be opposite each other. The face 305 may be away from the opening of the yoke 120. The face 301 may have a protrusion 310, the face 302 may have a protrusion 320, the face 303 may have a protrusion 330, and the face 304 may have a protrusion 340 (shown in FIG. 5). The protrusion 330 and the protrusion 340 are configured to be received or retained in openings or holes in the yoke 120.

FIG. 5 shows a different view of the components shown in FIG. 4. FIG. 5 also illustrates three of the six faces of the cross spider 300. The face 304 may have a protrusion 340. As stated, the protrusion 330 and the protrusion 340 are configured to be received in openings in the yoke 120.

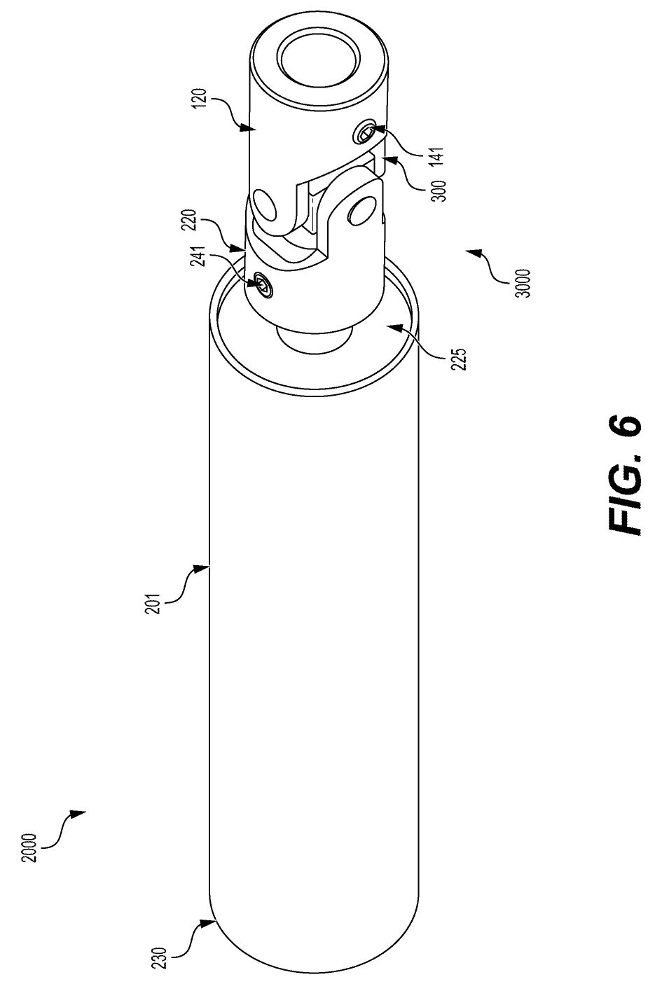

FIG. 6 illustrates the tube assembly 2000 and the joint assembly 3000. The tube 201 may be connected to the yoke 220, which is coupled to the yoke 120. The tube 201 has a sleeve 230 at one end. As discussed, the sleeve 230 is open at both of its ends. The tube 201 may include the first surface 225. The first surface 225 may be made of a similar material to the tube 201. The first surface 225 may be made of a harder material than the tube 201.

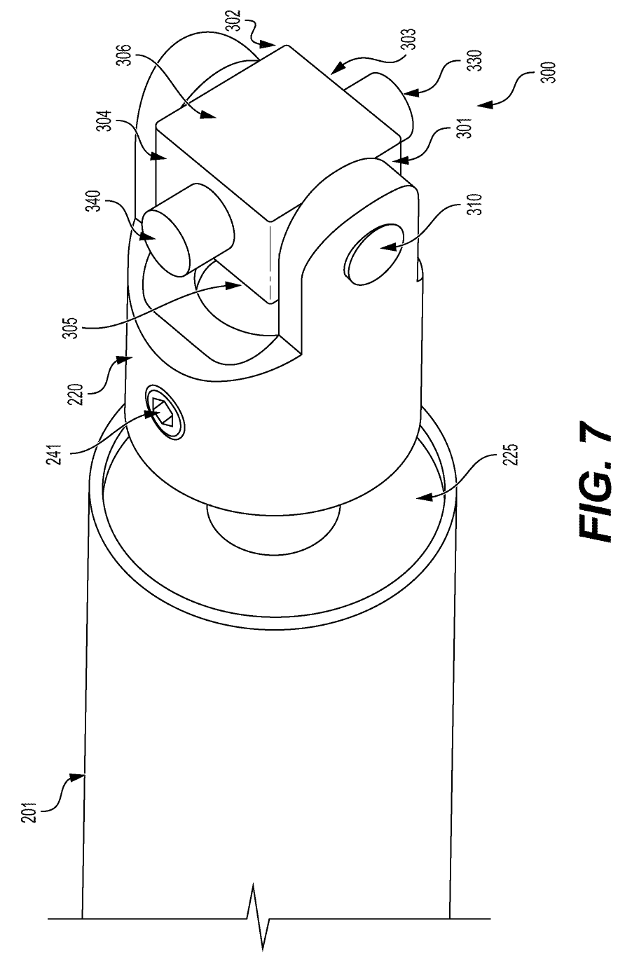

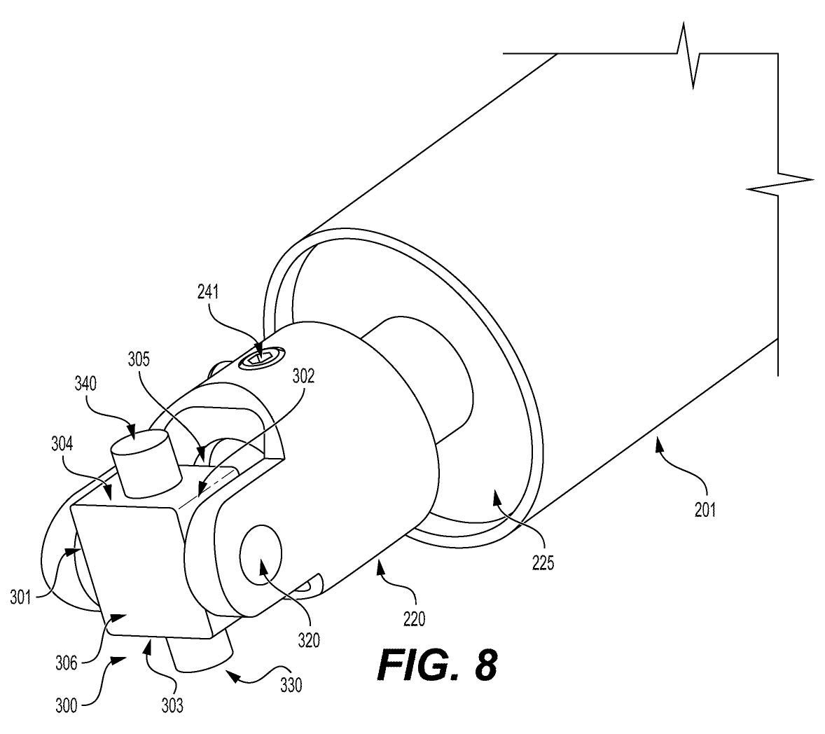

FIG. 7 show a detail view of a portion of the tube assembly 2000 and a portion of the joint assembly 3000. The yoke 220 may be coupled with the cross spider 300. For example, FIG. 7 shows four of the six faces of the cross spider 300. The face 301 may have a protrusion 310, the face 302 may have a protrusion 320 (shown in FIGS. 7 and 8), and the face 303 may have a protrusion 330, and the face 304 may have a protrusion 340. The protrusion 310 and the protrusion 320 (shown in FIGS. 7 and 8) are configured to be received within opening of the yoke 220.

FIG. 8 shows a different view of the portion of the tube assembly 2000 and a portion of the joint assembly 3000 of FIG. 7. FIG. 8 also illustrates three of the six faces of the cross spider 300. As discussed above with respect to FIG. 8, the face 302 may have a protrusion 320.

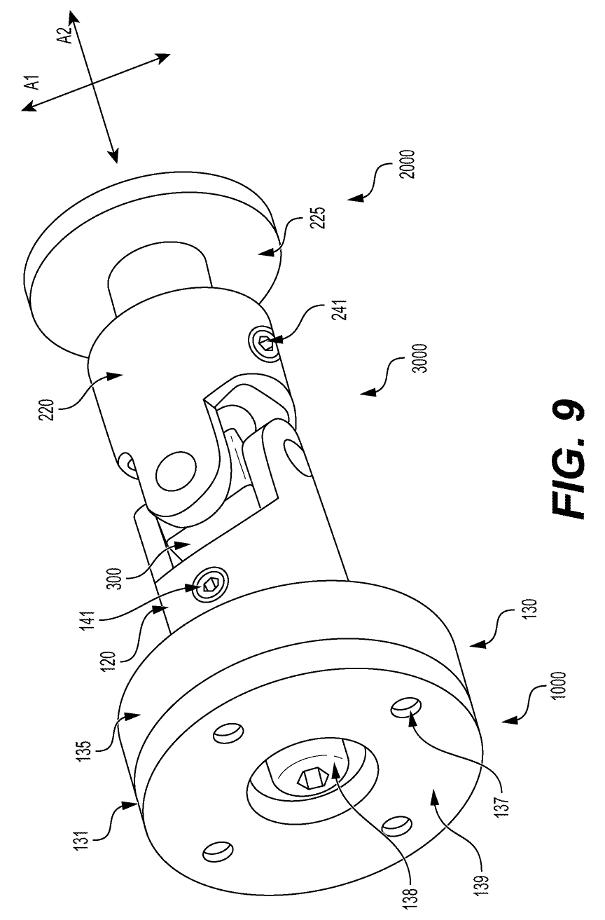

FIG. 9 shows the joint assembly 3000 and part of both the shaft assembly 1000 and the tube assembly 2000. The yoke 120 may be coupled to yoke 220 through the cross spider 300. The connector assembly 130 may be connected to the yoke 120. The base 131 of the connector assembly 130 may have a second surface 139 which faces in an opposite direction from the first surface 136 (not shown). The yoke 120 may be connected to the base 131 and the screw mount 135 using the connector 140 which has a screw 138 with a screw head facing the same direction as the second surface 139. The connector assembly may contain a plurality of screw holes 137. The plurality of screw holes 137 may allow the connector assembly to be connected to the shaft 101 (not shown). The yoke 220 may have a first surface 225. The cross spider 300 may allow for the yoke 120 and the yoke 220 to pivot relative to each other.

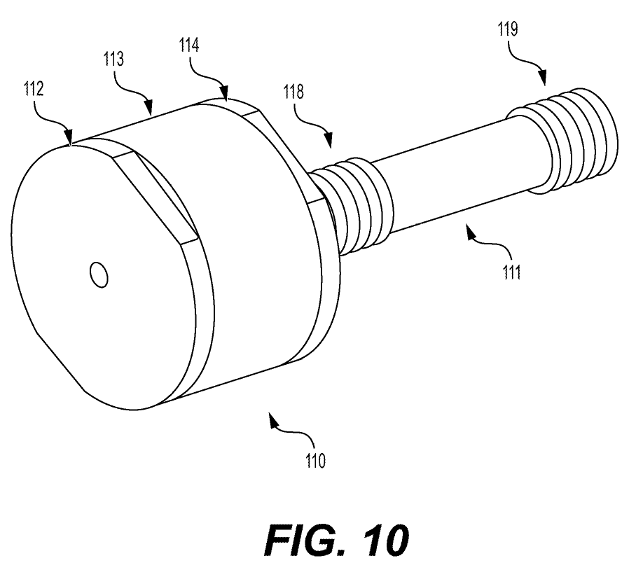

FIG. 10 shows the endcap 110. As discussed, the endcap 110 may include the partially threaded rod 111. The partially threaded rod 111 may include the first screw thread 119 and the second screw thread 118. The first screw thread 119 and the second screw thread 118 may be spaced apart from one another along the partially threaded rod 111. The endcap 110 may include the first washer 112, the first gripper 113, and the second washer 114. The first gripper 113 may be cylindrical, and the second washer 114 may be cylindrical. The partially threaded rod 111 may be made of a steel. The first gripper 113 may be made of a softer material than the first washer 112.

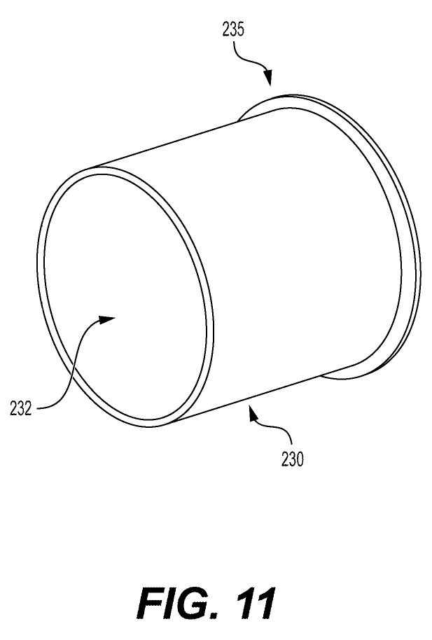

FIG. 11 shows the sleeve 230. The sleeve 230 may include the opening 232. The sleeve 230 may include a lip 235. The lip 235 may be wider than the sleeve 230, such that the sleeve 230 may be installed in the tube 201 while still remaining at the end of the tube 201. The sleeve 230 may be made of rubber.

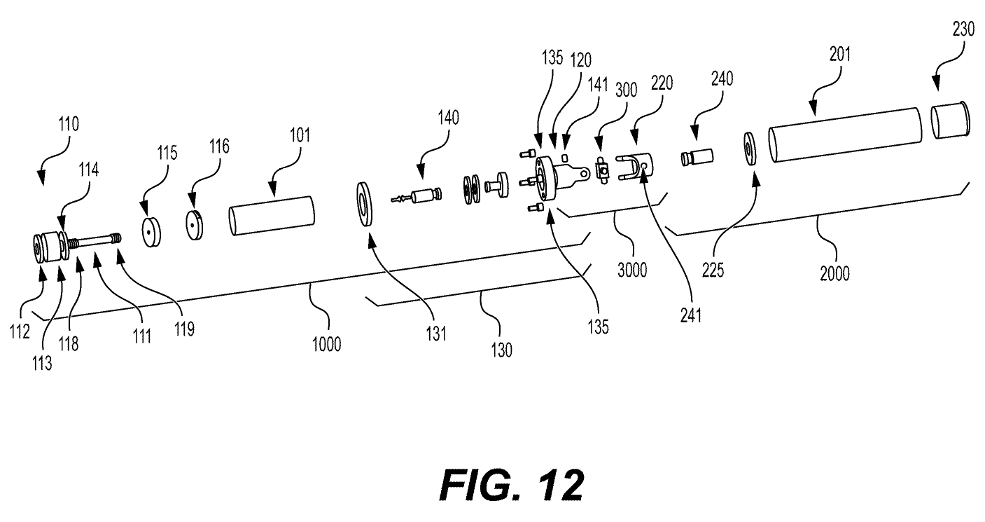

FIG. 12 shows an exploded view of a configuration of the exercise device 100. As discussed, the shaft assembly 1000 may be connected to the joint assembly 3000 by the connector 140 and the locking screw 141. The tube assembly 2000 may be connected to the joint assembly 3000 by the connector 240 and the locking screw 241.

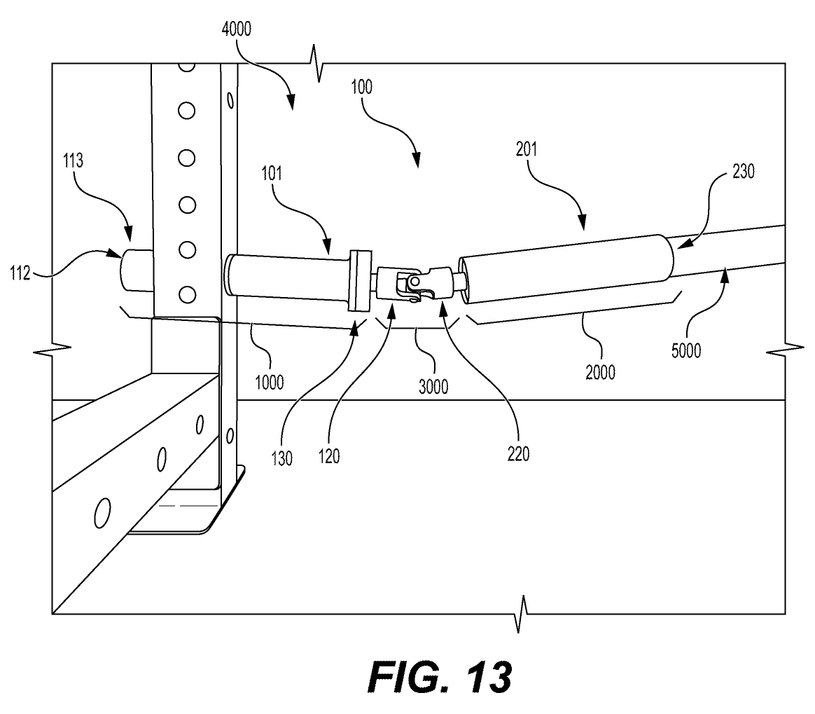

FIG. 13 illustrates a detail view of the exercise device 100 coupled with an exercise rack 4000 and an end of a barbell 5000. The end of the barbell 5000 may be received by the sleeve 230 of the tube assembly 2000. The second screw thread 118 of the endcap 110 may extend through a hole in the exercise rack 4000 and connected to the base 115, as previously described.

In accordance with the disclosure, a method of using the exercise device 100 with the exercise rack 4000 may include the following. A user of the exercise device 100 may remove the endcap 110 from the remainder of the exercise device 100. The user may insert the shaft 101 of the endcap 110 through a hole in the exercise rack 4000, depending on a desired location of the exercise device 100 relative to the rack 4000. The user may then threadingly connect the endcap 110 with the rest of the exercise device 100. More specifically, the first screw thread 119 of the endcap 110 may threadingly connect with the thread of the base 115, thereby securing the exercise device 100 to the rack 4000. The user may place an end of the barbell 5000, whether including weights or not, into the end of the shaft assembly 1000, such that the barbell 5000 extends through the sleeve 230 into an interior of the tube 201. The user may then add or remove weights from the barbell 5000.

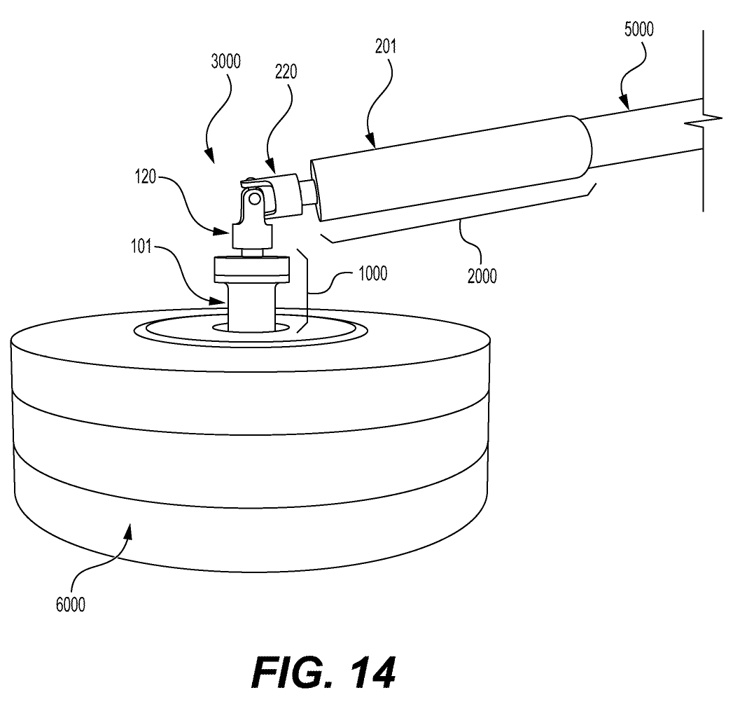

FIG. 14 illustrates a detail view of the exercise device 100 coupled with a plurality of bumper plates 6000 and an end of the barbell 5000. An end of the barbell 5000 may be received by the sleeve 230 of the tube assembly 2000. The first screw thread 119 of the endcap 110 may be connected to the base 115, and the shaft 101 may be inserted the center hole of the plurality of bumper plates 6000.

In accordance with the disclosure, a method of using the exercise device 100 with the bumper plates 6000 stacked on the floor may include the following. A user of the exercise device 100 may place the shaft 101 through the center holes of the bumper plates 6000, wherein the bumper plates 6000 are positioned flat on a floor surface. The exercise device 100 may or may not include the endcap 110. When the exercise device 100 includes the endcap 110, the second screw thread 118 may be threadingly connected with the threads of the base 115. In some embodiments, the weight plates *bumper plates 6000) may be 2 or 3 25-pound weight plates, or 2 45-pound weight plates.

### Clauses

The following clauses provide an exemplary configuration for an exercise device described above.

Clause 1. An exercise device, the exercise device comprising: a shaft assembly comprising a first end and a second end opposite the first end, wherein the shaft assembly comprises a shaft, a base with an internal thread at an end of the shaft, and an endcap threadingly connected to the base; a tube assembly comprising a first end and a second end opposite the first end, wherein the second end of the tube assembly is configured to receive an end of a barbell; and a joint assembly connecting the second end of the shaft assembly and the first end of the tube assembly.

Clause 2. The exercise device of clause 1, wherein the endcap includes a partially threaded rod, and a cylindrical gripper.

Clause 3. The exercise device of clause 2, wherein the internal thread of the base and the partially threaded rod cooperate with each other to removably attach the endcap to the shaft.

Clause 4. The exercise device of clause 1, wherein the joint assembly further comprises a cross spider, wherein the cross spider is a rectangular prism having a plurality of protrusions extending from faces of the rectangular prism.

Clause 5. The exercise device of clause 4, wherein a first pair of the plurality of protrusions extends from a first pair of opposite faces of the rectangular prism, and a second pair of the plurality of protrusions extend from a second pair of opposite faces of the rectangular prism.

Clause 6. The exercise device of clause 1, wherein the tube assembly includes a sleeve, wherein the sleeve is hollow and configured to accept the end of the barbell.

Clause 7. The exercise device of clause 6, wherein the sleeve is made of rubber.

Clause 8. The exercise device of clause 1, wherein the joint assembly further comprises a cross spider, wherein the cross spider is configured to permit the shaft assembly and tube assembly to pivot relative to each other .

Clause 9. An exercise assembly comprising: an exercise device comprising: a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread, and the endcap is configured to be connected to the internal thread of the base; a tube assembly comprising a first end and a second end opposite the first end, wherein the second end of the tube assembly is configured to receive an end of a barbell; and a joint assembly including yokes connecting the second end of the shaft assembly and the first end of the tube assembly, and a cross spider connecting the yokes to one another; and a barbell, wherein an end of the barbell is received in the second end of the tube assembly.

Clause 10. The exercise assembly of clause 9, wherein the endcap includes a partially threaded rod, and a cylindrical gripper.

Clause 11. The exercise assembly of clause 10, wherein the internal thread of the base and the partially threaded rod cooperate with each other to removably attach the endcap to the shaft.

Clause 12. The exercise assembly of clause 9, wherein the cross spider is a rectangular prism having a plurality of protrusions extending from faces of the rectangular prism.

Clause 13. The exercise assembly of clause 12, wherein a first pair of the plurality of protrusions extend from a first pair of opposite faces of the rectangular prism, and a second pair of the plurality of protrusions extend from a second pair of opposite faces of the rectangular prism.

Clause 14. The exercise assembly of clause 9, wherein the tube assembly includes a sleeve, wherein the sleeve is hollow and receives the end of the barbell.

Clause 15. The exercise assembly of clause 14, wherein the sleeve is made of rubber.

Clause 16. An exercise assembly comprising: an exercise device comprising: a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread spaced apart from one another, each of the first screw thread and the second screw thread threadingly connectable with the internal thread of the base; a tube assembly comprising a first end and a second end opposite the first end, wherein the second end of the tube assembly is configured to receive an end of a barbell; and a joint assembly including a first yoke connecting the second end of the shaft assembly and a second yoke connected to the first end of the tube assembly, and a cross spider connecting the first yoke and the second yoke to one another; and a barbell, wherein an end of the barbell is received in the second end of the tube assembly.

Clause 17. The exercise assembly of clause 16, wherein the cross spider is a rectangular prism having a plurality of protrusions extending from faces of the rectangular prism.

Clause 18. The exercise assembly of clause 17, wherein a first pair of the plurality of protrusions extend from a first pair of opposite faces of the rectangular prism, and a second pair of the plurality of protrusions extend from a second pair of opposite faces of the rectangular prism, the first pair retained in corresponding holes in the first yoke , and the second pair retained in corresponding holes in the second yoke.

Clause 19. The exercise assembly of clause 16, further comprising a sleeve retained in the second end of the tube assembly.

Clause 20. The exercise assembly of clause 19, wherein the barbell further comprises at least one weight plate.

Clause 21. A method of using the exercise device of clause 1, the method comprising: removing the endcap from the shaft; inserting the partially threaded rod through a hole in a rack; threading the partially threaded rod with the threaded end of the shaft assembly to secure the exercise device to the shaft; and placing a barbell into the tube assembly.

Clause 22. The method of clause 21, further comprising: unscrewing the endcap from the shaft, placing the partially threaded rod back through a hole on a crossmember or an upright of the rack, and screwing the endcap back into the shaft.

Clause 23. The method of clause 21, further comprising attaching the first screw thread to the threaded end of the shaft.

Clause 24. The method of clause 21, wherein the cross spider is configured to allow the shaft assembly and the tube assembly to move in perpendicular axes to each other.

Clause 25. The method of clause 21, wherein the cross spider is configured to allow the exercise device to move in a 180-degree angle perpendicular to the rack.

Clause 26. A method of using an exercise device of clause 1, the method comprising: placing the shaft through a center hole of a bumper plate, wherein the bumper plate is flatly positioned; and placing a barbell into the tube assembly.

Clause 27. The method of clause 26, further comprising attaching the second screw thread to the threaded end of the shaft.

Clause 28. The method of clause 26, further comprising flatly positioning a plurality of bumper plates, and placing the shaft through each central hole of each bumper plate.

Clause 29. The method of clause 28, wherein the plurality of bumper plates are 25-pound bumper plates.

Clause 30. The method of clause 28, wherein the plurality of bumper plates are 45-pound bumper plates.

Clause 31. The method of clause 26, wherein the cross spider is configured to allow the shaft assembly and the tube assembly to move in perpendicular axes to each other.

Clause 32. The method of clause 26, wherein the cross spider is configured to allow the exercise device to move in a 360-degree angle.

We Claim:

1. An exercise device, the exercise device comprising:
a shaft assembly comprising a first end and a second end opposite the first end, wherein the shaft assembly comprises a shaft, a base with an internal thread at an end of the shaft, and an endcap threadingly connected to the base;
a tube assembly comprising a first end and a second end opposite the first end, wherein the second end of the tube assembly is configured to receive an end of a barbell; and
a joint assembly connecting the second end of the shaft assembly and the first end of the tube assembly.

2. The exercise device of claim 1, wherein the endcap includes a partially threaded rod, and a cylindrical gripper.

3. The exercise device of claim 2, wherein the internal thread of the base and the partially threaded rod cooperate with each other to removably attach the endcap to the shaft.

4. The exercise device of claim 1, wherein the joint assembly further comprises a cross spider, wherein the cross spider is a rectangular prism having a plurality of protrusions extending from faces of the rectangular prism.

5. The exercise device of claim 4, wherein a first pair of the plurality of protrusions extends from a first pair of opposite faces of the rectangular prism, and a second pair of the plurality of protrusions extend from a second pair of opposite faces of the rectangular prism.

6. The exercise device of claim 1, wherein the tube assembly includes a sleeve, wherein the sleeve is hollow and configured to accept the end of the barbell.

7. The exercise device of claim 6, wherein the sleeve is made of rubber.

8. The exercise device of claim 1, wherein the joint assembly further comprises a cross spider, wherein the cross spider is configured to permit the shaft assembly and tube assembly to pivot relative to each other .

9. An exercise assembly comprising:
an exercise device comprising:
a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread, and the endcap is configured to be connected to the internal thread of the base;
a tube assembly comprising a first end and a second end opposite the first end, wherein the second end of the tube assembly is configured to receive an end of a barbell; and
a joint assembly including yokes connecting the second end of the shaft assembly and the first end of the tube assembly, and a cross spider connecting the yokes to one another; and
a barbell, wherein an end of the barbell is received in the second end of the tube assembly.

10. The exercise assembly of claim 9, wherein the endcap includes a partially threaded rod, and a cylindrical gripper.

11. The exercise assembly of claim 10, wherein the internal thread of the base and the partially threaded rod cooperate with each other to removably attach the endcap to the shaft.

12. The exercise assembly of claim 9, wherein the cross spider is a rectangular prism having a plurality of protrusions extending from faces of the rectangular prism.

13. The exercise assembly of claim 12, wherein a first pair of the plurality of protrusions extend from a first pair of opposite faces of the rectangular prism, and a second pair of the plurality of protrusions extend from a second pair of opposite faces of the rectangular prism.

14. The exercise assembly of claim 9, wherein the tube assembly includes a sleeve, wherein the sleeve is hollow and receives the end of the barbell.

15. The exercise assembly of claim 14, wherein the sleeve is made of rubber.

16. An exercise assembly comprising:
an exercise device comprising:
a shaft assembly comprising a first end and a second end opposite the first end, wherein the shaft assembly comprises a shaft, a base with an internal thread at an end of the shaft, and an endcap threadingly connected to the base, wherein the endcap comprises a partially threaded rod with a first screw thread and a second screw thread spaced apart from one another, each of the first screw thread and the second screw thread threadingly connectable with the internal thread of the base;
a tube assembly comprising a first end and a second end opposite the first end, wherein the second end of the tube assembly is configured to receive an end of a barbell; and
a joint assembly including a first yoke connecting the second end of the shaft assembly and a second yoke connected to the first end of the tube assembly, and a cross spider connecting the first yoke and the second yoke to one another; and
a barbell, wherein an end of the barbell is received in the second end of the tube assembly.

17. The exercise assembly of claim 16, wherein the cross spider is a rectangular prism having a plurality of protrusions extending from faces of the rectangular prism.

18. The exercise assembly of claim 17, wherein a first pair of the plurality of protrusions extend from a first pair of opposite faces of the rectangular prism, and a second pair of the plurality of protrusions extend from a second pair of opposite faces of the rectangular prism, the first pair retained in corresponding holes in the first yoke , and the second pair retained in corresponding holes in the second yoke.

19. The exercise assembly of claim 16, further comprising a sleeve retained in the second end of the tube assembly.

20. The exercise assembly of claim 19, wherein the barbell further comprises at least one weight plate.
